(19) United States
(12) Patent Application Publication
(10) Pub. No.: US 2021/0213955 A1
(43) Pub. Date: Jul. 15, 2021

(54) METHOD AND APPARATUS FOR EVALUATING A VEHICLE TRAVEL SURFACE

(71) Applicant: GM GLOBAL TECHNOLOGY OPERATIONS LLC, Detroit, MI (US)

(72) Inventors: Qingrong Zhao, Madison Heights, MI (US); Mohsen Khalili, Sterling Heights, MI (US); Bakhtiar B. Litkouhi, Washington, MI (US)

(73) Assignee: GM GLOBAL TECHNOLOGY OPERATIONS LLC, Detroit, MI (US)

(21) Appl. No.: 16/743,419

(22) Filed: Jan. 15, 2020

(51) Int. Cl. B60W 40/06; G06K 9/62; G01S 17/89; G06N 3/08; G01S 7/48; G06K 9/00; G06N 3/04

(52) U.S. Cl. CPC B60W 40/06; G06K 9/628; G06K 9/627; G01S 17/89; G06N 3/08; B60W 2420/62; G06K 9/00791; B60W 2555/20; G06N 3/04; B60W 2420/52; G01S 7/4808

(57) ABSTRACT

A method for evaluating a travel surface proximal to the vehicle is described, and includes generating, by the LiDAR sensor, a plurality of light pulses and capturing, by the LiDAR sensor, returned light data for the plurality of light pulses, wherein the light pulses are projected into a region of interest that includes the travel surface proximal to the vehicle, determining a multi-level image file based upon the returned light data for the plurality of light pulses, generating a trained classification model, and classifying the travel surface as one of a plurality of travel surface states based upon the multi-level image file and the trained classification model. Operation of the vehicle is controlled based upon the classifying of the travel surface.

### INTRODUCTION

Vehicle control systems may benefit from information related to conditions of a travel surface, and may employ such information as an input for controlling one or more systems such as braking, cornering and acceleration. Differing conditions of the travel surface may affect coefficients of friction between the tires and the travel surface. Dry travel surface conditions provide a high coefficient of friction, whereas snow covered travel conditions provide a lower coefficient of friction.

Light-detection and ranging (LiDAR) is an optical remote sensing technology that operates to acquire positional information of objects in a surrounding environment employing a light emitter and a light sensor. Operation of a LiDAR system includes illuminating objects in the surrounding environment with light pulses emitted from the light emitter, detecting light scattered by the objects using a light sensor such as a photodiode, and determining range of the objects based on the scattered light. The travel time of the light pulses to the photodiode can be measured, and a distance to an object can then be derived from the measured time. Vehicles employ LiDAR systems to detect, locate, and monitor objects in the surrounding environment.

It is desirable to be able to determine a current condition of a travel surface employing information from a LiDAR signal.

### SUMMARY

A vehicle including a light detection and ranging (LiDAR) sensor is described, wherein the LiDAR sensor generates a plurality of light pulses that are projected into a region of interest that includes a travel surface proximal to the vehicle. The LiDAR sensor also captures returned light data associated with the plurality of light pulses.

A method for evaluating a travel surface proximal to the vehicle is described, and includes generating, by the LiDAR sensor, a plurality of light pulses and capturing, by the LiDAR sensor, returned light data for the plurality of light pulses, wherein the light pulses are projected into a region of interest that includes the travel surface proximal to the vehicle, determining a multi-level image file based upon the returned light data for the plurality of light pulses, generating a trained classification model, and classifying the travel surface as one of a plurality of travel surface states based upon the multi-level image file and the trained classification model. Operation of the vehicle is controlled based upon the classifying of the travel surface.

An aspect of the disclosure includes classifying the travel surface as one of a dry travel surface, a wet travel surface, an ice-covered surface, a snow-covered surface including fresh snow, or a snow-covered surface including slushy snow.

Another aspect of the disclosure includes classifying the travel surface as one of the plurality of travel surface states based upon the multi-level image file and the trained classification model, including executing an artificial neural network to evaluate the multi-level image file based upon the trained classification model to classify the travel surface as one of the plurality of travel surface states. One embodiment of an artificial neural network is a convolutional neural network.

Another aspect of the disclosure includes generating the trained classification model by determining a training dataset that includes a plurality of datafiles associated with a plurality of sample travel surfaces, generating a multi-level image file for each of the plurality of datafiles, and generating the trained classification model by training an artificial neural network classifier based upon the multi-level image file for each of the plurality of datafiles and the associated plurality of sample travel surfaces.

Another aspect of the disclosure includes determining the training dataset that includes the plurality of datafiles associated with the plurality of sample travel surfaces by determining a datafile associated with each sample travel surface, wherein the plurality of sample travel surfaces includes a dry surface, a wet surface, an ice-covered surface, a snow-covered surface including fresh snow, and a snow-covered surface including slushy snow.

Another aspect of the disclosure includes generating the multi-level image file for each of the plurality of datafiles by generating the multi-level image file based upon the returned light data, wherein the returned light data includes returned energy intensity, XY position, Altitude Z, and Pulse ID for each of the plurality of datafiles associated with the plurality of sample travel surfaces.

Another aspect of the disclosure includes generating the multi-level image file based upon the returned light data by determining a first image based upon the returned light data for the plurality of light pulses, wherein the first image includes pulse identifiers and associated XY coordinate positions in a spatial domain for the returned light data for the plurality of light pulses; determining a second image based upon the returned light data for the plurality of light pulses, wherein the second image includes the altitude Z values associated with the XY coordinate positions in the spatial domain for the returned light data for the plurality of light pulses; determining a third image based upon the returned light data for the plurality of light pulses, wherein the third image includes the returned energy intensity associated with the XY coordinate positions in the spatial domain for the returned light data for the plurality of light pulses; and generating the multi-level image file based upon the first image, the second image, and the third image.

Another aspect of the disclosure includes evaluating a travel surface proximal to a vehicle by generating, by a light detection and ranging (LiDAR) sensor, a plurality of light pulses and capturing, by the LiDAR sensor, returned light data for the plurality of light pulses, wherein the light pulses are projected into a region of interest that includes the travel surface proximal to the vehicle; determining a first image based upon the returned light data for the plurality of light pulses, wherein the first image includes pulse identifiers and associated XY coordinate positions in a spatial domain for the returned light data for the plurality of light pulses; determining a second image based upon the returned light data for the plurality of light pulses, wherein the second image includes altitude Z values associated with the XY coordinate positions in the spatial domain for the returned light data for the plurality of light pulses; determining a third image based upon the returned light data for the plurality of light pulses, wherein the third image includes a returned energy intensity associated with the XY coordinate positions in the spatial domain for the returned light data for the plurality of light pulses; identifying a state of the travel surface proximal to the vehicle based upon the first, second, and third images; and controlling operation of the vehicle based upon the classifying of the travel surface.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a side-view of a vehicle including an on-vehicle vision system, wherein the vehicle is disposed on a travel surface, in accordance with the disclosure.

FIG. 2 schematically shows an isometric view of a vehicle operating on a travel surface, including returned light data from an on-vehicle LiDAR sensor for a field of view that includes a viewable region that is forward of the vehicle, in accordance with the disclosure.

FIG. 3 schematically shows a travel surface identification process for evaluating and classifying a travel surface that is proximal to a vehicle, in accordance with the disclosure.

FIG. 4-1 pictorially shows a first image of a travel surface that is damp and an associated graphical image of returned light data from an on-vehicle LiDAR sensor, wherein the graphical image of the returned light data is associated with a spatial domain in the form of an XY position for the travel surface, in accordance with the disclosure.

FIG. 4-2 pictorially shows a first image of a travel surface that is snow-covered with fresh snow and an associated graphical image of returned light data from an on-vehicle LiDAR sensor, wherein the graphical image of the returned light data is associated with a spatial domain in the form of an XY position for the travel surface, in accordance with the disclosure.

FIG. 4-3 pictorially shows a third image of a travel surface that is snow-covered with slushy snow and an associated graphical image of returned light data from an on-vehicle LiDAR sensor, wherein the graphical image of the returned light data is associated with a spatial domain in the form of an XY position for the travel surface, in accordance with the disclosure.

FIG. 4-4 graphically shows returned light data associated with altitude from an on-vehicle LiDAR sensor, wherein the graphical image of the returned light data is associated with a spatial domain in the form of a Z position (altitude) corresponding to the XY position for the travel surface, in accordance with the disclosure.

FIG. 4-5 graphically shows returned light data associated with returned energy intensity from an on-vehicle LiDAR sensor, wherein the graphical image of the returned light data is associated with the returned energy intensity corresponding to the XY position for the travel surface, in accordance with the disclosure.

FIG. 5 graphically shows a final image, which is a compilation of the XY position data associated with one of FIG. 4-1, 4-2 or 4-3, Z position (altitude) data associated with FIG. 4-4, and LiDAR returned energy intensity data associated with FIG. 4-5, in accordance with the disclosure.

FIG. 6 schematically shows an embodiment of an artificial neural network that includes five convolutional layers and one fully connected layer, in accordance with the disclosure.

It should be understood that the appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

As described herein, a concept, framework, methodologies and algorithms for detecting travel surface conditions using information from a LiDAR sensor through extraction and formulation of data into scalable multi-level images, generating separable datasets through association with a spatial domain, along with utilization of deep learning methodologies to obtain results with high resolution and good reliability.

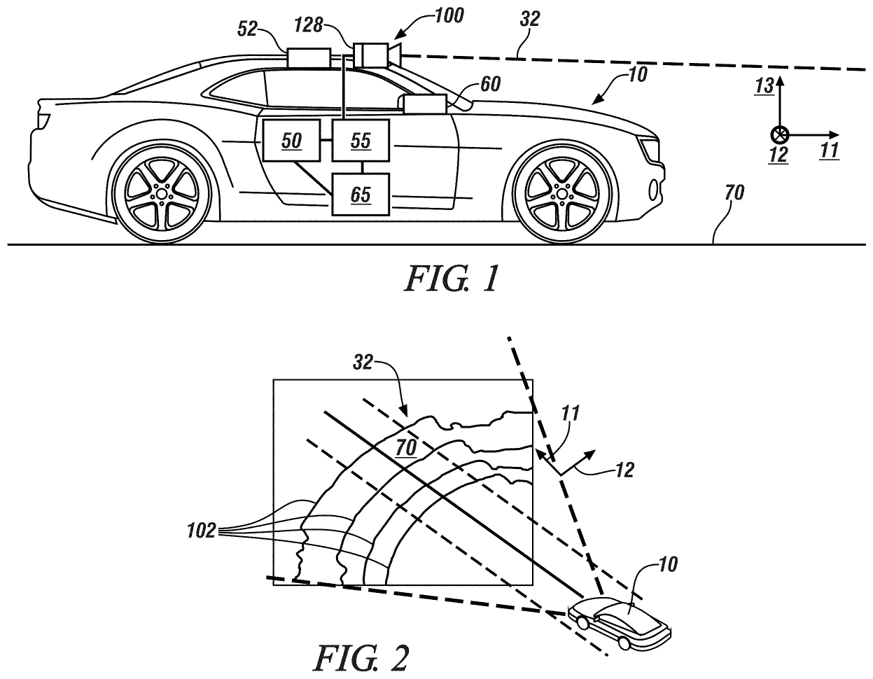

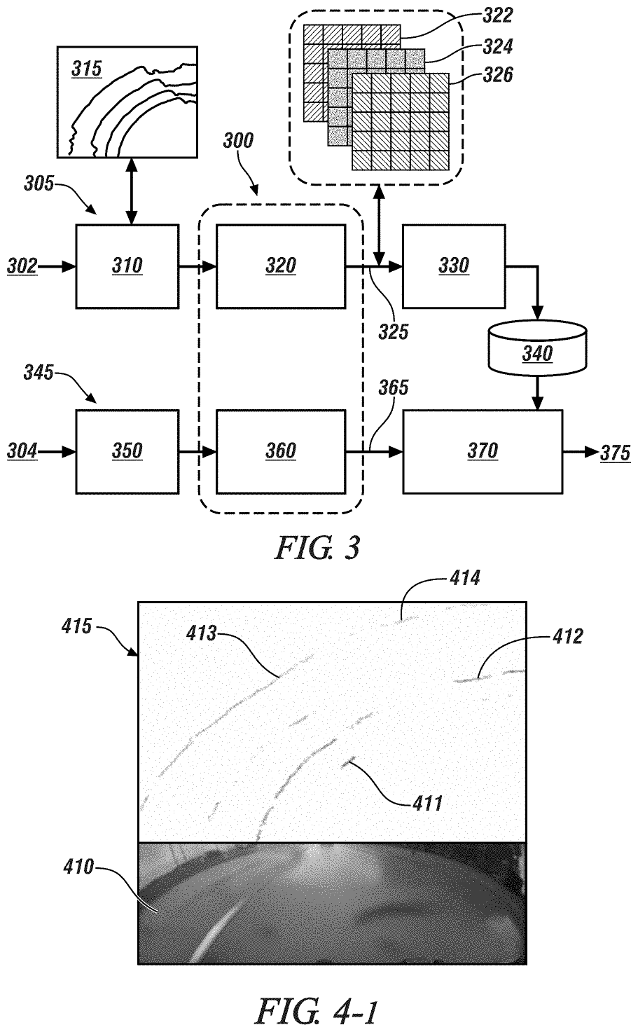

Referring to the drawings, wherein like reference numerals correspond to like or similar components throughout the several Figures, FIG. 1, consistent with embodiments disclosed herein, schematically illustrates an embodiment of a spatial monitoring system 100 including a light detection and ranging (LiDAR) sensor 128 and a spatial monitoring controller 55. A travel surface identification process 300 (described with reference to FIG. 3, et seq.) is employed to evaluate and classify a travel surface employing information derived from the LiDAR sensor 128. In one embodiment, and as described herein, the spatial monitoring system 100 is deployed on a vehicle 10. Alternatively, an embodiment of the spatial monitoring system 100 may be disposed on a stationary fixture that is in the vicinity of vehicle traffic, such as a utility pole, a bridge, etc., for the purpose of monitoring a travel surface.

The vehicle 10 on which the, the spatial monitoring system 100 and LiDAR sensor 128 are disposed may also include a vehicle controller 50, a global navigation satellite system (GNSS) sensor 52, and a human/machine interface (HMI) device 60. Other on-vehicle systems may include, by way of non-limiting examples, an on-board navigation system, a computer-readable storage device or media (memory) that includes a digitized roadway map, an autonomous control system, an advanced driver assistance system, a telematics controller, etc., all of which are indicated by autonomous controller 65. The concepts described herein may be employed on various systems that may benefit from information determined from an embodiment of the spatial monitoring system 100 in a manner that is described herein. The vehicle 10 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

A side-view of the vehicle 10 is shown, which is disposed on and able to traverse a travel surface 70 such as a paved travel surface. The vehicle 10 and the travel surface 70 define a spatial domain in the form of a three-dimensional coordinate system that includes a longitudinal (Y) axis 11, a lateral (X) axis 12 and an attitudinal (Z) axis 13. The longitudinal axis 11 is defined by a direction of travel of the vehicle 10 on the travel surface 70. The lateral axis 12 is defined as being orthogonal to the direction of travel of the vehicle 10 on the travel surface 70. The attitudinal axis 13 is defined as being orthogonal to a plane defined by the longitudinal axis 11 and the lateral axis 12, i.e., as projecting perpendicular to the travel surface 70.

The LiDAR sensor 128 is disposed on the vehicle 10 to monitor a viewable region 32 that is proximal to the vehicle 10. In one embodiment, the viewable region 32 is forward of the vehicle 10. The LiDAR sensor 128 includes a light emitter and a light sensor, and employs a pulsed and reflected laser pulse to measure range or distance to an object. In operation, light pulses are emitted from the light emitter, and the light sensor, e.g., a photodiode, detects light scattered by objects in the viewable region 32 to determine a range of the objects based on the scattered light. The term “returned light data” is employed herein to refer to light that originates from the light emitter and is detected by the photodiode of the LiDAR sensor 128. When employed in combination with information from the GNSS sensor 52, the spatial monitoring controller 55 is able to determine geospatial locations of objects that are in the viewable region 32 of the vehicle 10.

The spatial monitoring system 100 may include other spatial sensors and systems that are arranged to monitor the viewable region 32 forward of the vehicle 10 include, e.g., a surround-view camera, a forward-view camera, and a radar sensor, which may be employed to supplement or complement spatial information that is generated by the LiDAR sensor 128. Each of the spatial sensors is disposed on-vehicle to monitor all or a portion of the viewable region 32 to detect proximate remote objects such as road features, lane markers, buildings, pedestrians, road signs, traffic control lights and signs, other vehicles, and geographic features that are proximal to the vehicle 10. The spatial monitoring controller 55 generates digital representations of the viewable region 32 based upon data inputs from the spatial sensors. The spatial monitoring controller 55 can evaluate inputs from the spatial sensors to determine a linear range, relative speed, and trajectory of the vehicle 10 in view of each proximate remote object. The spatial monitoring controller 55 may operate to monitor traffic flow including proximate vehicles, intersections, lane markers, and other objects around the vehicle 10. Data generated by the spatial monitoring controller 55 may be employed by a lane marker detection processor (not shown) to estimate the roadway.

The term “controller” and related terms such as microcontroller, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example, each 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, an electromagnetic signal via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. A parameter is defined as a measurable quantity that represents a physical property of a device or other element that is discernible using one or more sensors and/or a physical model. A parameter can have a discrete value, e.g., either “1” or “0”, or can be infinitely variable in value.

FIG. 2 schematically shows an embodiment of the vehicle 10 described with reference to FIG. 1 operating on the travel surface 70 in context of a XY plane, which is depicted in context of the longitudinal and lateral axes 11, 12. Returned light data 102 from the on-vehicle LiDAR sensor 128 is also shown for a field of view that includes the viewable region 32 that is forward of the vehicle 10. Because the viewable region includes the travel surface area in front of the vehicle 10 and roadside areas adjacent to the travel lane, the returned light data 102 from the LiDAR sensor 128 may be used to monitor and differentiate travel surfaces, e.g., dry and snow surfaces.

The concepts described herein provide for LiDAR-based travel surface condition monitoring and detection to achieve high resolution and reliability by extracting and formulating returned light data, and information to multi-level image presentation and efficient feature exploration via deep learning technologies. The returned light data 102 can be characterized in terms of light returned energy intensity, XYZ position, and Pulse ID of the returned light that originates from the LiDAR sensor 128.

The LiDAR sensor 128 of the vehicle 10 generates a plurality of light pulses that are projected into a region of interest that includes a travel surface proximal to the vehicle 10. The LiDAR sensor 128 also captures returned light data that is associated with the plurality of light pulses. A travel surface identification process 300 is described with reference to FIG. 3, et seq., and includes one or a plurality of algorithms, an artificial neural network classifier, and associated calibrations for evaluating and classifying the travel surface proximal to the vehicle 10 employing information derived from the LiDAR sensor 128. The travel surface identification process 300 includes generating a plurality of light pulses and capturing the returned light data 102 from the plurality of light pulses employing the LiDAR sensor 128. A first image is formulated based upon the returned light data, wherein the first image includes pulse identifiers and associated XY coordinate positions in a spatial domain for the returned light data. A second image is formulated based upon the returned light data, wherein the second image includes Z values associated with the XY coordinate positions in the spatial domain for the returned light data. A third image is formulated based upon the returned light data, wherein the third image includes a returned energy intensity associated with the XY coordinate positions in the spatial domain for the returned light data. A state of the travel surface proximal to the vehicle is determined based upon the first, second, and third images. This includes analyzing the first, second, and third images employing the artificial neural network classifier to classify the travel surface. The classified travel surfaces can include a dry surface, a wet surface, an ice-covered surface, a snow-covered surface including fresh snow, slushy snow, etc., and other travel surfaces.

The travel surface identification process 300 can be implemented on an embodiment of the vehicle 10 that is described with reference to FIG. 1. The travel surface identification process 300 is executable to classify the travel surface 70 on which the vehicle 10 is travelling based upon information that is obtained by the LiDAR sensor 128. In one embodiment, the travel surface identification process 300 is executable in the spatial monitoring controller 55. Light intensity is demonstrated to be low on reflective surfaces (watery surface), and is generally high on non-reflective surfaces such as dry, fresh snow, slush snow, etc. However, to differentiate dry and different types of snow, the pulse ID and the XYZ coordinates of return light are more prominent features than the intensity. Due to the height of snow, the returned light has less |Z| value on snow than dry surface, whereas slush snow may have an uneven surface, so the returned light for each pulse may have different heights, which is shown as ripples on the XY coordinate plane. When a dry surface is encountered, a curb on a roadside can be captured indicating a height difference.

Referring again to FIG. 3, the travel surface identification process 300 includes a travel surface training element 305 and a travel surface execution element 345. Overall, the travel surface training element 305 employs a training dataset 302 to generate a trained classification model 340. The travel surface execution element 345 evaluates real-time returned light data 304 using the trained classification model 340 to classify the travel surface state 375 in real-time. The classified travel surfaces can include, by way of non-limiting examples, a dry surface, a wet surface, an ice-covered surface, a snow-covered surface including fresh snow, slushy snow, etc.

The training dataset 302 includes returned light data for each of a dry surface, a wet surface, an ice-covered surface, snow-covered surfaces including fresh snow, slushy snow, etc., wherein the returned light data is characterized in terms of returned energy intensity, XY position, Altitude Z, and Pulse ID in one embodiment. It is appreciated that the returned light data may be characterized in other terms or additional terms within the scope of this disclosure. The training dataset 302 includes a plurality of datafiles, an example of which is shown as datafile 315 containing returned light data that are generated by an embodiment of the LiDAR sensor that is monitoring a corresponding plurality of sample travel surfaces, wherein each of the sample travel surfaces exhibits a single surface condition that is homogeneous in appearance. The sample surface conditions include, e.g., a dry travel surface, a wet travel surface, an ice-covered surface, snow-covered surfaces including fresh snow, slushy snow, etc. The returned light data associated with the sample travel surfaces of the training dataset 302 may be generated off-line, and the sample travel surfaces may be created under idealized or controlled conditions.

The travel surface training element 305 includes an ROI extraction step 310, a multi-level image formulation step 320, and an artificial neural network (ANN) classifier training step 330 to generate the trained classification model 340.

The travel surface training element 305 processes the training dataset 302 through the ROI extraction step 310, the multi-level image formulation step 320, and the ANN classifier training step 330 to generate the trained classification model 340.

The steps of processing the training dataset 302 through the ROI extraction step 310, the multi-level image formulation step 320, and the ANN classifier training step 330 are executed iteratively, with each iteration being executed to process one of the sample surface conditions of the training dataset 302 to generate a multi-level image file 325 for one of the returned light data of the training dataset 302 representing one of the single surface conditions. The travel surface training element 305 may be executed off-line, with results stored in a memory device of the spatial monitoring controller 55, or elsewhere.

The returned light data of the training dataset 302 are subjected to steps that include the ROI extraction step 310, the multi-level image formulation step 320, and the ANN classifier training step 330 to for the trained classification model 340.

The ROI extraction step 310 includes noise removal and extraction of one or more regions of interest that are representative of and correspond to the respective surface condition for one set of the returned light data of the training dataset 302. Datafiles are captured that are extracted portions of the image files.

The multi-level image formulation step 320 generates the multi-level image file 325 for one of the returned light data of the training dataset 302 representing one of the single surface conditions, taking into account a spatial domain-based signal correlation and distribution. The multi-level image file 325 includes, in one embodiment, a first image file 322, a second image file 324, and a third image file 326. Additional or different image files may be derived from the returned light data of the training dataset 302, with corresponding development of ROI extraction steps, multi-level image formulation steps, and artificial neural (ANN) network classification steps and associated analysis to perform travel surface identification in a manner that is described herein.

The multi-level image formulation step 320 determines a unique multi-level image file 325 for each set of the returned light data of the training dataset 302 associated with one of the single surface conditions.

The first image file 322 includes pulse ID relevant information of the returned light data in their associated XY positions in order to explore and identify any pulse shift in the XY plane. By way of example, when the travel surface is snow-covered, the pulse often shifts toward the right-bottom corner with smaller XY. The first image file 322 can be employed to explore correlation patterns of returned light data points in a returned pulse and among different pulses in order to capture LiDAR pulse shape changes on different surfaces.

For returned light data points that are elements of the same pulse, their pixel values in the first image file are identical. Each pulse is assigned with a pixel value that is different from other pulses, which, for instance, can be expressed as follows:

$$P ( XY ) = \{ \begin{matrix}i * K + d & if ( XY ) ∈ pulse i ( i = 0 , 1 , 2 , 3 … ) \\ 0 & otherwise\end{matrix}$$

wherein

P(X,Y) is the pixel value at (X, Y)position,

i is the pulse ID i,

K is a gain to enlarge the number, and

d is an initial pixel value to offset when pulse ID is 0

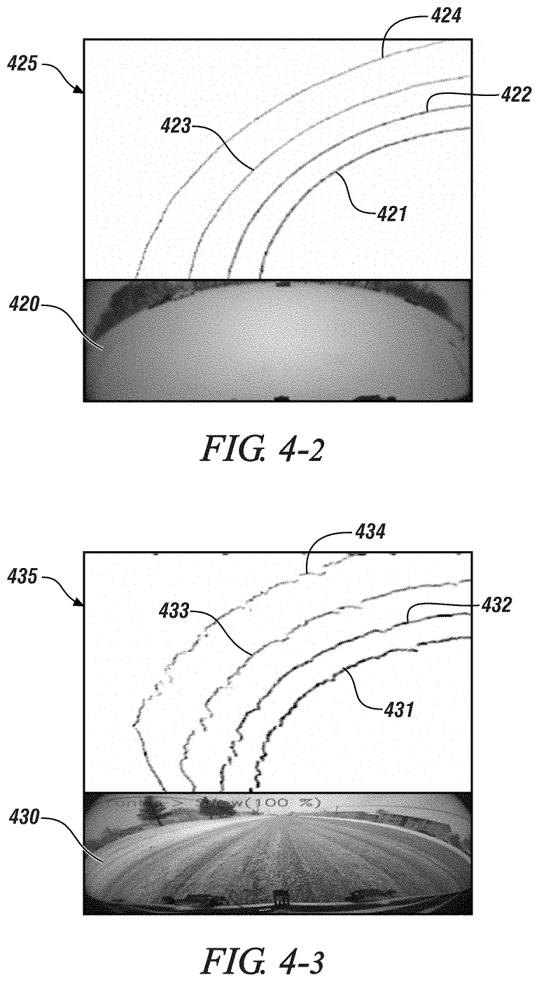

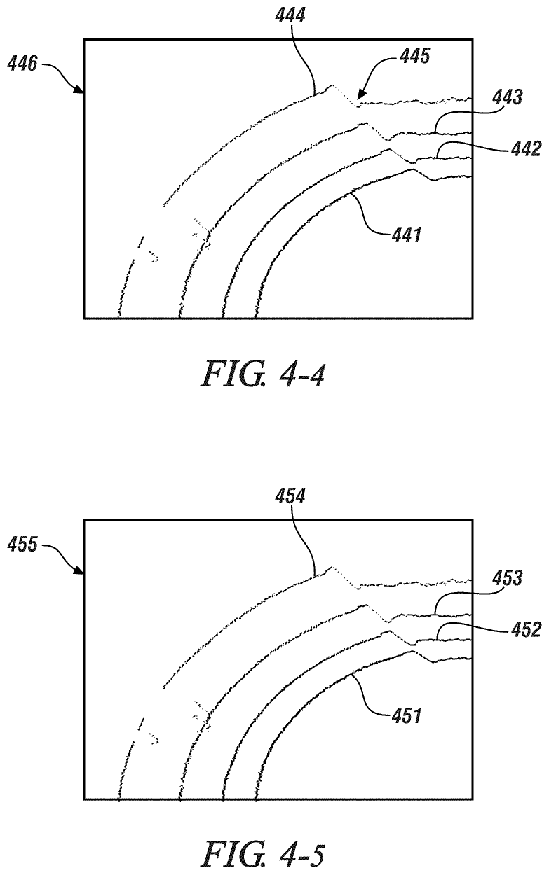

FIG. 4-1 graphically shows a first image 410 and first returned light data 415 in the form of LiDAR signals 411, 412, 413 and 414, which provide an example of the returned light data associated with the spatial domain, i.e., the XY position, for a travel surface that is damp. The LiDAR signals 411, 412, 413 and 414 for the example returned light data point associated with the spatial domain for the damp travel surface include corresponding pixel values 63, 127, 191, and 255, respectively, which are associated with LiDAR pulse IDs 0, 2, 4, and 6, respectively. The LiDAR signals 411, 412, 413 and 414 associated with the damp travel surface in the first image 410 exhibit intermittent pulse shapes.

FIG. 4-2 graphically shows a second image 420 and second returned light data 425 in the form of LiDAR signals 421, 422, 423 and 424, which provide an example of the returned light data associated with the spatial domain, i.e., the XY position, for a travel surface that is snow-covered with fresh snow. The LiDAR signals 421, 422, 423 and 424 for the example returned light data point associated with the spatial domain for the fresh snow travel surface include corresponding pixel values 63, 127, 191, and 255, respectively, which are associated with LiDAR pulse IDs 0, 2, 4, and 6, respectively. The LiDAR signals 421, 422, 423 and 424 associated with the fresh snow travel surface in the second image 420 exhibit smooth pulse shapes.

FIG. 4-3 graphically shows a third image 430 and third returned light data 435 in the form of LiDAR signals 431, 432, 433 and 434, which provide an example of the returned light data associated with the spatial domain, i.e., the XY position, for a travel surface that is snow-covered with slushy snow. The LiDAR signals 431, 432, 433 and 434 for the example returned light data point associated with the spatial domain for the slushy snow travel surface include corresponding pixel values 63, 127, 191, and 255, respectively, which are associated with LiDAR pulse IDs 0, 2, 4, and 6, respectively. The LiDAR signals 431, 432, 433 and 434 associated with the slushy snow travel surface in the third image 430 exhibit rippled pulse shapes.

Referring again to FIG. 3, the second image file 324 includes Z position information of the returned light data in the XY position in the spatial domain. This helps differentiate (1) snow (fresh/slush) from other types of surfaces, e.g., a dry surface. Snow in general increases the surface height and therefore the returned light data point has smaller absolute Z value in the LiDAR coordinate system than on dry or wet travel surfaces. The Z values of the returned light data points returned from dry and fresh snow should show similar numbers, whereas the Z value of data points from slush snow should show fluctuation due to the uneven surfaces. This information may also differentiate a watery surface from an object in a travel path. An example formulation for the second image file 324 includes a Z value for returned light data from the ground being negative in the LiDAR coordinate system. Based upon an installation position of the LiDAR sensor 128 on the vehicle 10, the max |Z| value to the normal ground (can be denoted at L=max|Z|). Z value for any returned light data point from a travel surface will fall into [−L, 0]. The pixel value for each returned light data, denoted by P, in the second image file 324 is a number in the range of [0, 255], which, for instance, can be calculated based on:

$$P ( XY ) = \frac{Z - 0.0}{- L - 0.0} * 255$$

wherein:

X, Y, Z is the coordinate of a returned light data point, and

L is the maximum of absolute Z value.

FIG. 4-4 graphically shows Z position data 446, including LiDAR signals 441, 442, 443 and 444, which provide an example of returned light data associated with altitude, i.e., the Z position, for a travel surface that is dry. The LiDAR signals 441, 442, 443 and 444 for the example returned light data associated with the spatial domain for the dry travel surface include corresponding pixel values 63, 127, 191, and 255, respectively, which are associated with LiDAR pulse IDs 0, 2, 4, and 6, respectively. The LiDAR signals 441, 442, 443 and 444 associated with the dry travel surface indicate the travel surface and a curb portion 445.

Referring again to FIG. 3, the third image file 326 includes returned energy intensity of the returned light data associated with the spatial domain, i.e., the XY position. This can include capturing travel surfaces that return big differences of energy intensity, such as wet or ice as compared to dry and snow. The returned energy intensity is captured and patterned in the spatial domain to help achieve higher resolution. For example, the intensity level shows a statistical similarity on fresh and slush snow, whereas the association with the returned position can still show different patterns in spatial domain via different intensity values from roadside scene. The pixel value associated with each returned light data at the XY position is the returned energy intensity value of the returned light data point. Other pixel values in the image plane are assigned with Os. This, for instance, can be expressed as follows:

$$P ( XY ) = \{ \begin{matrix}{I}_{( XY )} & if ( XY ) are corrdinates of LiDAR points \\ 0 & otherwise\end{matrix}$$

wherein:

P(XY) is the pixel value at (XY)position, and

I_{(XY)} is the returned energy intensity of the LiDAR point at the (XY) position.

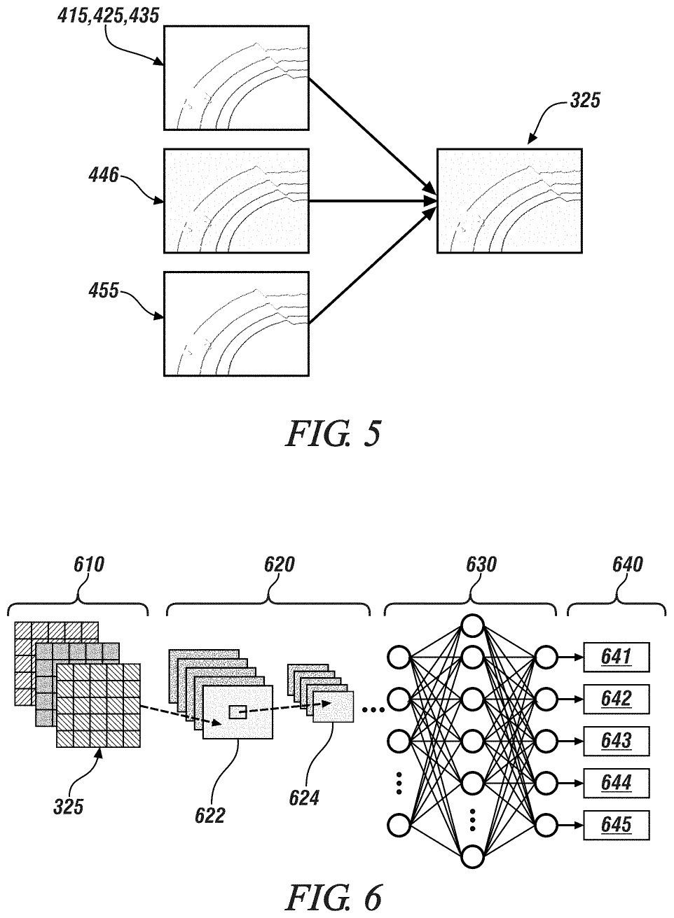

FIG. 4-5 graphically shows LiDAR returned energy intensity data 455, including LiDAR signals 451, 452, 453 and 454 associated with returned energy intensity, which provide an example of a returned light data point associated with the XY position, for a dry travel surface. The LiDAR signals 451, 452, 453 and 454 for the example returned light data point associated with the spatial domain for the dry travel surface include corresponding pixel values 63, 127, 191, and 255, respectively, which are associated with LiDAR pulse IDs 0, 2, 4, and 6, respectively.

FIG. 5 graphically shows an example of the multi-level image file 325, which is a compilation of the XY position associated pulse ID data (FIG. 4-1, 4-2, or 4-3), Z position data 446 (FIG. 4-4), and returned energy intensity data 455 (FIG. 4-5) of the returned light data points. The multi-level image formulation step 320 determines a unique multi-level image file 325 for each set of the returned light data of the training dataset 302 associated with one of the single surface conditions. Thus, as appreciated, there are multiple multi-level image files 325, with a unique multi-level image file 325 being generated for each of the sample surface conditions including, e.g., a dry travel surface, a wet travel surface, an ice-covered surface, snow-covered surfaces including fresh snow, slushy snow, etc.

Referring again to FIG. 3, the ANN classifier training step 330 employs the multi-level image file 325 including the XY position associated pulse ID data, the Z position data, and the returned energy intensity data, in conjunction with the identified sample travel surface exhibiting a single surface condition that is homogeneous in appearance to generate the trained classification model 340. The ANN classifier training step 330 includes employing machine learning tools such as a convolutional neural network (ConvNet) deep learning analysis, or another analytical process to learn and train the trained classification model 340 based upon the multi-level image file 325 and the identified sample travel surface exhibiting the single surface condition.

The travel surface execution element 345 includes an ROI extraction step 350, a multi-level image formulation step 360, and an artificial neural (ANN) network classification step 370. The travel surface execution element 345 evaluates the real-time returned light data 304 using the trained classification model 340 to classify the travel surface state 375 in real-time. The classified travel surface states may include, by way of non-limiting examples, a dry surface, a wet surface, an ice-covered surface, a snow-covered surface including fresh snow, slushy snow, etc.

The ROI extraction step 350 is analogous to the ROI extraction step 310 of the travel surface training element 305, and includes noise removal and extraction of one or more regions of interest of the real-time returned light data 304. The multi-level image formulation step 360 is analogous to the multi-level image formulation step 320 of the travel surface training element 305, and includes generating a multi-level image file 365 for the real-time returned light data 304, including XY position data, Z position data, and returned energy intensity data.

The artificial neural network (ANN) classification step 370 evaluates the multi-level image file 365 in context of the trained classification model 340, and classifies the travel surface that is associated with the real-time returned light data 304 as being one of a dry surface, a wet surface, an ice-covered surface, a snow-covered surface including fresh snow, slushy snow, etc. by comparison with the contents of the trained classification model 340.

In one embodiment, the ANN associated with the ANN classification step 370 includes five convolutional layers and one fully connected layer. This arrangement is shown schematically with reference to FIG. 6, which includes an input image 610, e.g., image 325, which is input to convolutional layers 620 including convolution layer 622 and pooling layer 624, a fully connected layer 630, and an output class 640, which is in the form of travel surface classifications, including, e.g., the dry travel surface 641, wet travel surface 642, ice-covered surface 643, snow-covered surface including fresh snow 644, and a snow-covered surface including slushy snow 645.

In one embodiment, an image analysis process may be based on image processing that includes hand-crafted feature analysis approach, which may include manually extracting features, then training of classifiers separately based on machine learning. Alternatively, or in addition, a deep learning approach may be employed to unify the feature extraction process and the classification step through several layers of neural network. During execution of a neural network training process, the parameters of the neural network will be learned, and then in real time the real time image is fed into the trained neural network. Offline training and online analysis are based on training to learn the unknown parameters, with the online analysis executed to feed images into the parameter-learned approach for classification.

The travel surface state 375 may be communicated to the vehicle controller 50, which may employ the travel surface state 375 for generating warning or advisory information, or for vehicle dynamic control related to acceleration, braking and cornering. The travel surface state 375 may also be communicated to the vehicle operator via a human-machine interface (HMI) device 60. The travel surface state 375 may also be communicated to a telematics controller for short-range vehicle-to-vehicle (V2V) communication, communication to an intelligent highway system, or communication to another extra-vehicle system.

When implemented on an embodiment of the vehicle 10 having autonomous functionality, the results from the travel surface identification process 300 can be employed by the autonomous controller 65 to autonomously actuate vehicle braking for mitigating condensation build-up on vehicle brakes. Furthermore, the travel surface state 375 from travel surface identification process 300 can be employed by the autonomous controller 65 to autonomously actuate a traction control system for mitigating condensation build-up on vehicle brakes. Furthermore, the results from the travel surface identification process 300 can be communicated via a wireless communication system for alerting other vehicles of the surface condition. Furthermore the results from the travel surface identification process 300 can be employed by the autonomous controller 65 and the HMI device 60 to alert a driver of a potential reduced traction between vehicle tires and the path of travel surface, and alert a driver of the vehicle against a use of automated features, such as cruise control.

The block diagrams in the flow diagrams illustrate the architecture, functionality, and operation of possible implementations of systems, methods, and computer program products according to various embodiments of the present disclosure. In this regard, each block in the block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for evaluating a travel surface proximal to a vehicle, the method comprising:
generating, by a light detection and ranging (LiDAR) sensor, a plurality of light pulses and capturing, by the LiDAR sensor, returned light data for the plurality of light pulses, wherein the light pulses are projected into a region of interest that includes the travel surface proximal to the vehicle;
determining a multi-level image file based upon the returned light data for the plurality of light pulses;
classifying the travel surface as one of a plurality of travel surface states based upon the multi-level image file and a trained classification model; and
controlling operation of the vehicle based upon the classifying of the travel surface.

2. The method of claim 1, wherein classifying the travel surface as one of a plurality of travel surface states comprises classifying the travel surface as one of a dry travel surface, a wet travel surface, an ice-covered surface, a snow-covered surface including fresh snow, or a snow-covered surface including slushy snow.

3. The method of claim 1, wherein classifying the travel surface as one of the plurality of travel surface states based upon the multi-level image file and the trained classification model comprises executing an artificial neural network to evaluate the multi-level image file based upon the trained classification model to classify the travel surface as one of the plurality of travel surface states.

4. The method of claim 1, further comprising generating the trained classification model, comprising:
determining a training dataset including a plurality of datafiles associated with a plurality of sample travel surfaces;
generating a multi-level image file for each of the plurality of datafiles; and
generating the trained classification model by training an artificial neural network classifier based upon the multi-level image file for each of the plurality of datafiles and the associated plurality of sample travel surfaces.

5. The method of claim 4, wherein determining the training dataset including the plurality of datafiles associated with the plurality of sample travel surfaces comprises determining a datafile associated with each sample travel surface, wherein the plurality of sample travel surfaces includes a dry surface, a wet surface, an ice-covered surface, a snow-covered surface including fresh snow, and a snow-covered surface including slushy snow.

6. The method of claim 4, wherein generating the multi-level image file for each of the plurality of datafiles includes generating the multi-level image file based upon the returned light data, wherein the returned light data includes returned energy intensity, XY position, Altitude Z, and Pulse ID for each of the plurality of datafiles associated with the plurality of sample travel surfaces.

7. The method of claim 6, wherein generating the multi-level image file based upon the returned light data, wherein the returned light data includes the returned energy intensity, XY position, altitude Z, and pulse identification for each of the plurality of datafiles associated with the plurality of sample travel surfaces comprises:
determining a first image based upon the returned light data for the plurality of light pulses, wherein the first image includes pulse identifiers and associated XY position in a spatial domain for the returned light data for the plurality of light pulses;
determining a second image based upon the returned light data for the plurality of light pulses, wherein the second image includes the altitude Z values associated with the XY position in the spatial domain for the returned light data for the plurality of light pulses;
determining a third image based upon the returned light data for the plurality of light pulses, wherein the third image includes the returned energy intensity associated with the XY position in the spatial domain for the returned light data for the plurality of light pulses; and
generating the multi-level image file based upon the first image, the second image, and the third image.

8. A method of evaluating a travel surface proximal to a vehicle, the method comprising:
generating, by a light detection and ranging (LiDAR) sensor, a plurality of light pulses and capturing, by the LiDAR sensor, returned light data for the plurality of light pulses, wherein the light pulses are projected into a region of interest that includes the travel surface proximal to the vehicle;
determining a first image based upon the returned light data for the plurality of light pulses, wherein the first image includes pulse identifiers and associated XY position in a spatial domain for the returned light data for the plurality of light pulses;
determining a second image based upon the returned light data for the plurality of light pulses, wherein the second image includes altitude Z values associated with the XY position in the spatial domain for the returned light data for the plurality of light pulses;
determining a third image based upon the returned light data for the plurality of light pulses, wherein the third image includes a returned energy intensity associated with the XY position in the spatial domain for the returned light data for the plurality of light pulses;
classifying a state of the travel surface proximal to the vehicle based upon the first, second, and third images; and
controlling operation of the vehicle based upon the classifying of the travel surface.

9. The method of claim 8, wherein identifying the state of the travel surface proximal to the vehicle based upon the first, second, and third images further comprises:
generating a trained classification model; and
classifying the travel surface as one of a plurality of travel surface states based upon the first, second, and third images and the trained classification model.

10. The method of claim 9, wherein classifying the travel surface as one of a plurality of travel surface states comprises classifying the travel surface as one of a dry travel surface, a wet travel surface, an ice-covered surface, a snow-covered surface including fresh snow, or a snow-covered surface including slushy snow.

11. The method of claim 9, wherein classifying the travel surface as one of the plurality of travel surface states based upon the first, second, and third images and the trained classification model comprises executing an artificial neural network to evaluate the first, second, and third images based upon the trained classification model to classify the travel surface as one of the plurality of travel surface states.

12. The method of claim 9, wherein generating the trained classification model comprises:
determining a training dataset including a plurality of datafiles associated with a plurality of sample travel surfaces; and
generating the trained classification model by training an artificial neural network classifier based upon the plurality of datafiles and the associated plurality of sample travel surfaces.

13. A vehicle disposed on a travel surface, comprising:
a light detection and ranging (LiDAR) sensor, a vehicle system, and a controller;
the controller operably connected to the vehicle and in communication with the LiDAR sensor, the controller including an instruction set, the instruction set being executable to:
generate, by the LiDAR sensor, a plurality of light pulses and capturing, by the LiDAR sensor, returned light data for the plurality of light pulses, wherein the light pulses are projected into a region of interest that includes the travel surface proximal to the vehicle,
determine a multi-level image file based upon the returned light data for the plurality of light pulses,
classify the travel surface as one of a plurality of travel surface states based upon the multi-level image file and a trained classification model, and
control operation of the vehicle system based upon the classifying of the travel surface.

14. The vehicle of claim 13, wherein the instruction set being executable to classify the travel surface as one of a plurality of travel surface states comprises the instruction set being executable to classify the travel surface as one of a dry travel surface, a wet travel surface, an ice-covered surface, a snow-covered surface including fresh snow, or a snow-covered surface including slushy snow.

15. The vehicle of claim 13, wherein the instruction set being executable to classify the travel surface as one of the plurality of travel surface states based upon the multi-level image file and the trained classification model comprises the instruction set including an artificial neural network that is executable to evaluate the multi-level image file based upon the trained classification model to classify the travel surface as one of the plurality of travel surface states.

16. The vehicle of claim 13, further comprising the instruction set being executable to generate the trained classification model, comprising the instruction set being executable to:
determine a training dataset including a plurality of datafiles associated with a plurality of sample travel surfaces,
generate a multi-level image file for each of the plurality of datafiles, and
generate the trained classification model by training an artificial neural network classifier based upon the multi-level image file for each of the plurality of datafiles and the associated plurality of sample travel surfaces.

17. The vehicle of claim 16, wherein the instruction set being executable to determine the training dataset including the plurality of datafiles associated with the plurality of sample travel surfaces comprises the instruction set being executable to determine a datafile associated with each sample travel surface, wherein the plurality of sample travel surfaces includes a dry surface, a wet surface, an ice-covered surface, a snow-covered surface including fresh snow, and a snow-covered surface including slushy snow.

18. The vehicle of claim 16, wherein the instruction set being executable to generate the multi-level image file for each of the plurality of datafiles comprises the instruction set being executable to generate the multi-level image file based upon the returned light data, wherein the returned light data includes returned energy intensity, XY position, Altitude Z, and Pulse ID for each of the plurality of datafiles associated with the plurality of sample travel surfaces.

19. The vehicle of claim 18, wherein the instruction set being executable to generate the multi-level image file based upon the returned light data, wherein the returned light data includes the returned energy intensity, XY position, altitude Z, and pulse identification for each of the plurality of datafiles associated with the plurality of sample travel surfaces comprises the instruction set being executable to:
determine a first image based upon the returned light data for the plurality of light pulses, wherein the first image includes pulse identifiers and associated XY position in a spatial domain for the returned light data for the plurality of light pulses,
determine a second image based upon the returned light data for the plurality of light pulses, wherein the second image includes the altitude Z values associated with the XY position in the spatial domain for the returned light data for the plurality of light pulses,
determine a third image based upon the returned light data for the plurality of light pulses, wherein the third image includes the returned energy intensity associated with the XY position in the spatial domain for the returned light data for the plurality of light pulses, and
generate the multi-level image file based upon the first image, the second image, and the third image.
